(19) United States
(12) Patent Application Publication
(10) Pub. No.: US 2025/0353339 A1
(43) Pub. Date: Nov. 20, 2025

(54) WHEEL FOR VEHICLE

(71) Applicant: Shinji NAGAOKA, Yawata-shi (JP)

(72) Inventor: Shinji NAGAOKA, Yawata-shi (JP)

(21) Appl. No.: 19/100,178

(22) PCT Filed: Aug. 4, 2023
(86) PCT No.: PCT/JP2023/028594

§ 371 Date: Jan. 31, 2025

(30) Foreign Application Priority Data
Aug. 4, 2022 (JP) 2022-124988

(51) Int. Cl. B60F 3/00; B60B 7/14; B60B 19/06

(52) U.S. Cl. CPC B60F 3/0007; B60B 7/14; B60B 19/06

(57) ABSTRACT

Provided is a vehicle wheel with which it is possible to obtain a large propulsive force. The vehicle wheel comprises: a wheel portion to be mounted to a hub provided at the end of a drive axle for a drive wheel of the vehicle body; a wheel cover portion detachably mounted to the wheel portion; and a detach/attach mechanism portion that detachably fixes the wheel cover portion to the wheel portion. The wheel cover portion has a drum shape with a thickness in the shaft center direction of the wheel portion, and comprises a plurality of concave puddle portions in the peripheral surface portion thereof. The detach/attach mechanism portion includes: a plurality of mating recess portions provided on the wheel portion; a plurality of mating protrusion portions provided on the wheel cover portion so as to be matable with the plurality of mating recess portions; and a fixing portion that detachably fixes the mating between the plurality of mating recess portions and the plurality of mating protrusion portions. The fixing portion includes: a center screw hole portion provided in the wheel portion on the shaft center, a center hole provided in the wheel cover portion on the shaft center, a center bolt member that threadedly engaged in the center screw hole portion through the center hole; and a stopper screw for preventing the loosening of the center bolt member threadedly engaged in the center screw hole portion.

### TECHNICAL FIELD

The present invention relates to wheels for vehicles.

### BACKGROUND ART

Patent Literatures (PTLs) 1 and 2, for example, each disclose a vehicle having a mechanism (referred to below as a thrust force generation mechanism) that generates propulsion force through rotation of wheels (drive wheels) when the vehicle is moving on water.

The thrust force generation mechanism of the vehicle described in PTL 1 includes a pair of paddle members attached to left and right rear wheels (drive wheels). Each of the paddle members has a disk-shaped paddle mounting plate and a plurality of paddle plates (paddle blades) arranged on one surface (outer surface) of the paddle mounting plate at equal intervals in the circumferential direction. The plurality of paddle plates are arranged in a radial pattern centered around the rotational center of the paddle mounting plate. The outer diameter of the paddle members is greater than the inner diameter of tires. The left and right rear wheels each have a plurality of bolt insertion holes around the rotational center thereof. The paddle mounting plates also each have a plurality of bolt insertion holes arranged at equal intervals around the rotational center thereof in the circumferential direction. A plurality of fixing bolts for left and right rear wheel hubs are inserted in the bolt insertion holes of the left and right rear wheels and the left and right paddle members, and nuts are screwed and thereby tightened onto ends of the fixing bolts, so that the left and right paddle members are fixed to the left and right rear wheels.

The thrust force generation mechanism of the vehicle described in PTL 2 includes a plurality of paddle blades integrally provided on each of left and right outer sides of the left and right drive wheels, and arranged at equal intervals in the circumferential direction. In other words, some of a plurality of spokes of each of the left and right drive wheels protrude outward in the left-right direction, forming the plurality of paddle blades.

### CITATION LIST

### Patent Literature

PTL 1: Japanese Unexamined Patent Application Publication No. 2002-211223

PTL 2: Japanese Unexamined Patent Application Publication No. 2016-210261

### SUMMARY OF THE INVENTION

### Technical Problem

In the case of the thrust force generation mechanism disclosed in PTL 1, an area of each paddle member toward an outer peripheral portion pushes water to generate thrust force when the paddle members rotate in a direction for moving the vehicle forward. However, an area of each paddle member toward the rotational center generates eddy currents that contribute little to the propulsion, making it difficult to efficiently generate thrust force.

In the case of the thrust force generation mechanism of the vehicle disclosed in PTL 2, the plurality of paddle blades on the left and right drive wheels protrude outward in the axial direction. However, the protrusion is limited to an amount that keeps the paddle blades from protruding further outward than fenders. That is, the amount of the outward protrusion of the plurality of paddle blades in the axial direction is small. This makes it difficult to generate sufficient propulsion force through the rotation of the drive wheels in the direction for moving the vehicle forward. Furthermore, an area of the plurality of paddle blades toward the rotational axis generates eddy currents that contribute little to the propulsion, making it difficult to efficiently generate thrust force.

The present invention aims to provide wheels for vehicles designed with the aforementioned circumstances taken into account.

### Solution to Problem

The present invention provides a wheel for a vehicle.

This wheel for a vehicle includes: a wheel portion that is attached to a hub provided on an end of a drive wheel drive shaft in a body of the vehicle; a wheel cover portion that is detachably attached to the wheel portion; and an attachment/detachment mechanism portion that detachably fixes the wheel cover portion to the wheel portion. The wheel cover portion has a drum-like shape having a thickness in a direction of a central axis of the wheel portion and includes a plurality of recess-shaped paddle portions in an outer peripheral surface portion thereof. The attachment/detachment mechanism portion has a plurality of mating recess portions provided on the wheel portion, a plurality of mating protrusion portions provided on the wheel cover portion so as to be fittable into the plurality of mating recess portions, and a fixing portion that releasably fixes mating between the plurality of mating recess portions and the plurality of mating protrusion portions. The fixing portion has a center threaded hole portion provided on the central axis in the wheel portion, a center hole provided on the central axis in the wheel cover portion, a center bolt member that is screwed into the center threaded hole portion through the center hole, and a stopper screw that prevents the center bolt member screwed into the center threaded hole portion from loosening.

A wheel for a vehicle according to another aspect includes: a wheel portion that is attached to a hub provided on an end of a drive wheel drive shaft in a body of the vehicle; a wheel cover portion that is detachably attached to the wheel portion; and an attachment/detachment mechanism portion that detachably fixes the wheel cover portion to the wheel portion. The wheel cover portion has a drum-like shape having a thickness in a direction of a central axis of the wheel portion and includes a plurality of recess-shaped paddle portions in an outer peripheral surface portion thereof. The attachment/detachment mechanism portion has a plurality of mating recess portions provided on the wheel portion, a plurality of mating protrusion portions provided on the wheel cover portion so as to be fittable into the plurality of mating recess portions, and a fixing portion that releasably fixes mating between the plurality of mating recess portions and the plurality of mating protrusion portions. One mating protrusion portion of the plurality of mating protrusion portions has an extension portion extending outward in a radial direction. One mating recess portion of the plurality of mating recess portions has a hook-shaped locking recess portion that is open inward in the radial direction so as to receive the extension portion of the one mating protrusion portion.

A wheel for a vehicle according to another aspect includes: a wheel portion that is attached to a hub provided on an end of a drive wheel drive shaft in a body of the vehicle; a wheel cover portion that is detachably attached to the wheel portion; and an attachment/detachment mechanism portion that detachably fixes the wheel cover portion to the wheel portion. The wheel cover portion has a drum-like shape having a thickness in a direction of a central axis of the wheel portion and includes a plurality of recess-shaped paddle portions in an outer peripheral surface portion thereof. The attachment/detachment mechanism portion has a plurality of mating recess portions provided on the wheel portion, a plurality of mating protrusion portions provided on the wheel cover portion so as to be fittable into the plurality of mating recess portions, and a fixing portion that releasably fixes mating between the plurality of mating recess portions and the plurality of mating protrusion portions. The plurality of mating recess portions are each open toward the central axis in a direction perpendicular to the central axis so as to receive the plurality of mating protrusion portions.

### Advantageous Effects of Invention

A wheel for a vehicle according to the present invention makes it possible to generate propulsion force by rotating a wheel cover portion thereof having a drum-like shape together with a wheel portion thereof in a direction for moving the vehicle forward with the wheel underwater, and thus causing paddle portions provided in the wheel cover portion to rotate and push water. In a case where such wheels are mounted on an off-road vehicle and slip while the off-road vehicle is running through a swamp or a river, for example, it is possible to generate propulsion force through the rotation of some of the paddle portions located underwater. Since the wheel cover portion has a drum-shaped structure, the paddle portions are less likely to break even if, for example, the paddle portions come into contact with stones or rocks on the riverside while the vehicle is running in the river. In a case where such wheels are mounted on an amphibious vehicle that travels in water, for another example, it is possible to generate propulsion force through the rotation of the paddle portions.

### BRIEF DESCRIPTION OF THE DRAWINGS

FIG. 1 is a left side view of a vehicle equipped with wheels according to a first embodiment of the present invention.

FIG. 2 is a perspective view of a wheel (left front wheel) according to the first embodiment.

FIG. 3 is a longitudinal sectional view of the wheel according to the first embodiment taken along the central axis of rotation thereof.

FIG. 4 is a diagram corresponding to FIG. 3 and showing an exploded view of the wheel.

FIG. 5 is an external view of an outer surface of a wheel portion of the wheel according to the first embodiment.

FIG. 6 is a perspective view of a wheel (left front wheel) according to the first embodiment.

FIG. 7 is an explanatory diagram illustrating the vehicle equipped with the wheels according to the first embodiment, moving forward with part thereof submerged in water.

FIG. 8 is a longitudinal sectional view for illustrating a first procedure for attaching a wheel cover portion to the wheel portion of the first embodiment.

FIG. 9 is a longitudinal sectional view for illustrating a second procedure for attaching the wheel cover portion to the wheel portion of the first embodiment.

FIG. 10 is an external view of the inner surface of the wheel cover portion of the wheel according to the first embodiment.

FIG. 11 is a longitudinal sectional view of a wheel according to a second embodiment taken along the central axis of rotation thereof.

FIG. 12 is a longitudinal sectional view for illustrating a procedure for attaching a wheel cover portion to a wheel portion of the second embodiment.

FIG. 13 is an external view of an outer surface of the wheel portion of the wheel according to the second embodiment.

FIG. 14 is an external view of an inner surface of the wheel cover portion of the wheel according to the second embodiment.

FIG. 15 is a longitudinal sectional view of a wheel according to a third embodiment taken along the central axis of rotation thereof.

FIG. 16 is a longitudinal sectional view for illustrating a procedure for attaching a wheel cover portion to a wheel portion of the third embodiment.

FIG. 17 is an explanatory diagram illustrating a vehicle equipped with wheels according to a fourth embodiment, moving forward with part thereof submerged in water.

### DETAILED DESCRIPTION

The following describes the present invention in further detail with reference to the drawings. It should be noted that the description provided below is intended to be illustrative in all respects and should not be construed as limiting the scope of the invention.

### First Embodiment

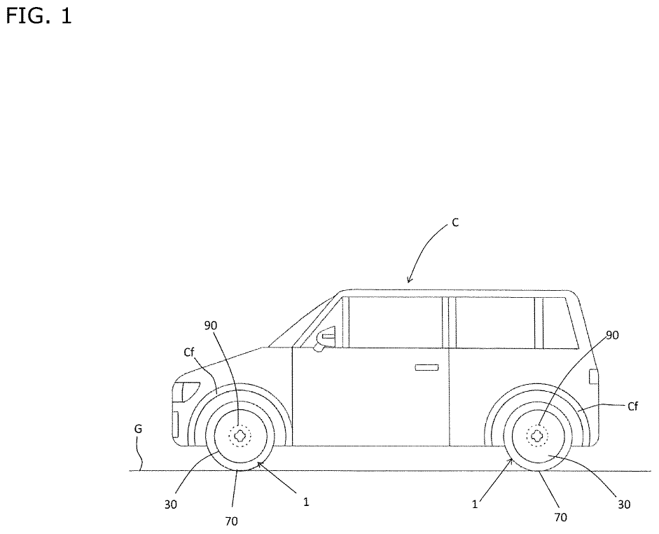

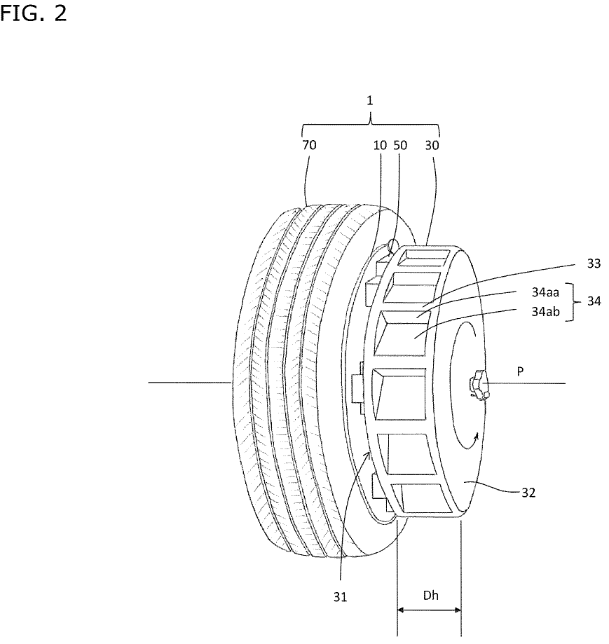

FIG. 1 is a left side view of a vehicle equipped with wheels according to a first embodiment of the present invention. FIG. 2 is a perspective view of one of the wheels (left rear wheel) according to the first embodiment. In FIG. 2, an arrow A indicates the direction of rotation of a wheel 1 in a case where a vehicle C moves forward.

FIG. 1 shows, as an example of the vehicle C, a four-wheel-drive (all-wheel-drive) off-road vehicle, which is one form of the vehicle according to the present invention. It should be noted that a reference sign G represents the ground, and a reference sign Cf represents a fender of the vehicle C.

The vehicle C includes four drive wheels in total in the front-back and left-right directions, and hubs 90, which each have a plurality of fixing bolts 91, on ends of drive shafts for the four drive wheels. The vehicle C has wheels 1 shown in FIG. 2 attached as the left and right front wheels and the left and right rear wheels.

As shown in FIG. 2, each of the wheels 1 includes a wheel portion 10, a wheel cover portion 30, an attachment/detachment mechanism portion 50, and a tire 70.

The tire 70 is attached to the wheel portion 10. The wheel cover portion 30 is detachably attached to the wheel portion 10 with the attachment/detachment mechanism portion 50 therebetween. The wheel cover portion has a substantially drum-like shape having a thickness Dh in a direction along the drive shaft, which is indicated by a central axis P of the rotation of the wheel 1 in FIG. 2.

The wheel cover portion 30 has a substantially disk-shaped inner surface portion 31 (hidden by an outer peripheral surface portion 33 in FIG. 1), which is fixed to the wheel portion 10 with the attachment/detachment mechanism portion 50 therebetween, on one side in the direction of the central axis P and a substantially disk-shaped outer surface portion 32 on an opposite side. The wheel cover portion 30 further has the outer peripheral surface portion 33 between the outer edge of the inner surface portion 31 and the outer edge of the outer surface portion 32. The outer peripheral surface portion 33 has a plurality of paddle portions 34 arranged in a direction along the circumference thereof. As shown in FIG. 1, each of the paddle portions 34 includes a first surface 34aa and a second surface 34ab that are located radially inward of the outer peripheral surface portion 33. Thus, sequences of the outer peripheral surface 33, and the first surfaces 34aa and the second surfaces 34ab of the paddle portions 34 form a shape having repeated peaks and troughs in the outer circumferential direction.

As described above, the wheel cover portion 30 is a substantially drum-shaped portion including the inner surface portion 31, the outer surface portion 32, and the outer peripheral surface portion 33, and has a shape similar to a waterwheel that has the plurality of paddle portions 34 formed in the outer peripheral surface portion 33 and that rotates around the central axis P.

Although an off-road vehicle is shown in FIG. 1 as an example of the vehicle C to which the wheels 1 according to the present embodiment are suitably applied, the vehicle C is not limited to being of the off-road type. Furthermore, the wheels 1 are applicable to wheels of amphibious vehicles as well as vehicles that run on land. Power units (motive power generation devices) of these vehicles are not particularly limited, and may be electric power units or internal combustion engine power units.

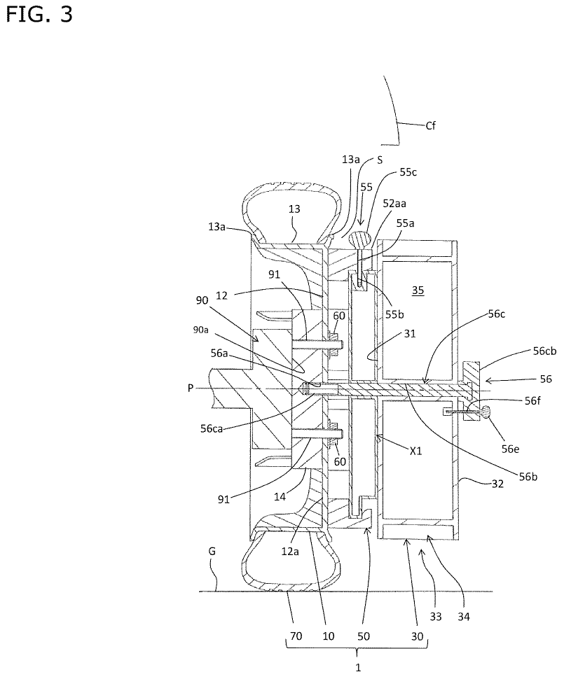

FIG. 3 is a longitudinal sectional view of the wheel according to the first embodiment taken along the central axis of rotation thereof. In FIG. 3, the reference sign G represents the ground, and the reference sign Cf represents a fender of the vehicle C.

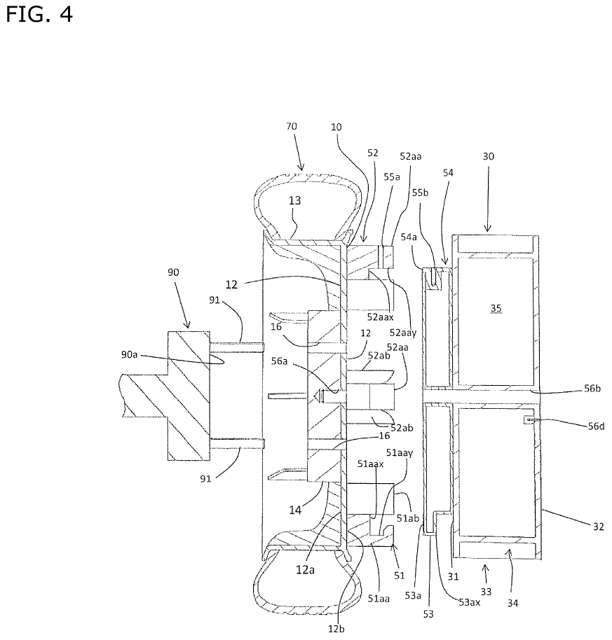

FIG. 4 is a diagram corresponding to FIG. 3 and showing an exploded view of the wheel.

As shown in FIGS. 3 and 4, the wheel portion 10 is attached to the hub (wheel hub) 90 of the vehicle. The wheel cover portion 30 is detachably attached to an outer side of the wheel portion 10 that faces away from the hub 90 in the direction of the central axis P. The hub 90 has four fixing bolts (hub bolts) 91 arranged at equal intervals on a circle centered around the central axis P. The four fixing bolts 91 protrude from an end surface 90a of the hub 90 in the direction of the central axis P (outward). When the wheel 1 is in a state in which the wheel portion 10 and the wheel cover portion 30 are attached to the hub 90, the central axis P of the hub 90 and the central axis of the wheel 1 (the central axis of the wheel portion 10 and the central axis of the wheel cover portion 30) are substantially coincident.

### <Wheel Portion>

As shown in FIGS. 3 and 4, the tire 70 is a general tire that is filled with compressed air and supports the wheel portion 10. Basically, the tire 70 is a tubeless tire, but may alternatively be a tube tire.

The wheel portion 10 includes a disk portion 12 centered around the central axis P, a short cylindrical outer peripheral portion 13 that is continuously provided along the outer peripheral edge of the disk portion 12 and that protrudes toward the hub 90, and a disk-shaped thickened portion 14 that is provided on an inner surface 12a of the disk portion 12 opposed to the hub 90 and that is centered around the central axis P.

As shown in FIG. 3, a pair of annular rims 13a protruding outward in the radial direction are provided on the outer peripheral portion 13, and the tire 70 is mounted between the pair of rims 13a.

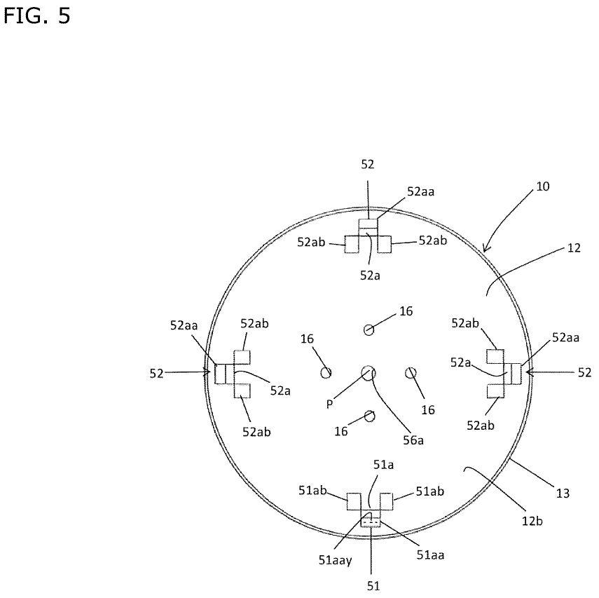

FIG. 5 is an external view of an outer surface of the wheel portion of the wheel according to the first embodiment (surface opposite to the inner surface that is attached to the hub 90).

As shown in FIGS. 3 to 5, the disk portion 12 and the thickened portion 14 have four bolt insertion holes 16 that are arranged on a circle centered around the central axis P, and that allow the four fixing bolts 91 of the hub 90 to be inserted therein. Onto the four fixing bolts 91 of the hub 90 inserted in the four bolt insertion holes 16 of the wheel portion 10, nut members 60 are respectively screwed with washers therebetween, and thus the wheel portion 10 is attached to the hub 90 as shown in FIG. 3. The wheel portion 10 further has a center threaded hole portion 56a that penetrates through the disk portion 12 along the central axis P and reaches a predetermined depth of the thickened portion 14.

As shown in FIGS. 4 and 5, the attachment/detachment mechanism portion 50, which is described below, is provided on an outer surface 12b opposite to the inner surface 12a of the disk portion 12 of the wheel portion 10.

The wheel portion 10 may be made of metal and formed as a single piece by casting, forging, or machining, among other methods. Alternatively, the wheel portion 10 may be formed by integrating the components (the disk portion 12, the outer peripheral portion 13, and the thickened portion 14) through welding.

### <Wheel Cover Portion>

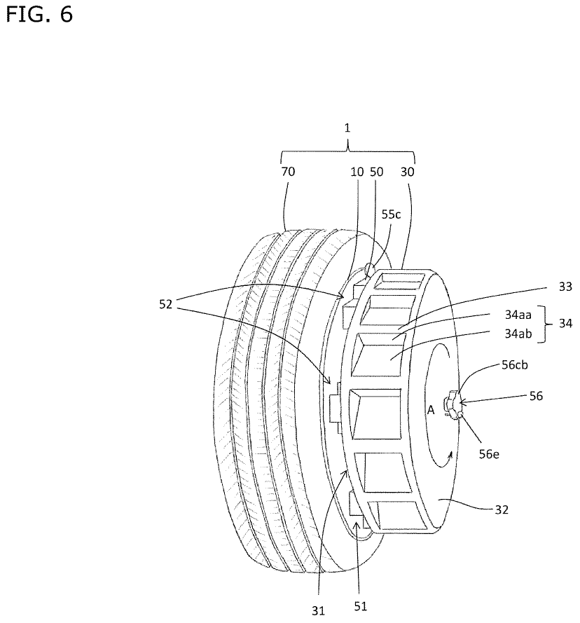

FIG. 6 is a perspective view of the wheel (left rear wheel) according to the first embodiment.

As shown in FIGS. 6 and 3, the wheel cover portion 30 has the circular inner surface portion 31 that is opposed to the outer surface 12b of the wheel portion 10, the circular outer surface portion 32 located opposite to the inner surface portion 31, the outer peripheral surface portion 33 located between the outer edge of the inner surface portion 31 and the outer edge of the outer surface portion 32, and the plurality of paddle portions 34 provided in the outer peripheral surface portion 33. The wheel cover portion 30 has a shape of a waterwheel that rotates around the central axis P, which is shared with the hub 90. The outer diameter of the wheel cover portion 30 is smaller than the outer diameter of the tire 70, and is substantially the same as the outer diameter of the wheel portion 10. The wheel cover portion 30 of the present embodiment is a resin or rubber molded product and has a hermetically sealed inner space portion 35. The wheel cover portion 30 may be made of metal, or may be formed from a composite material of resin, rubber, and metal.

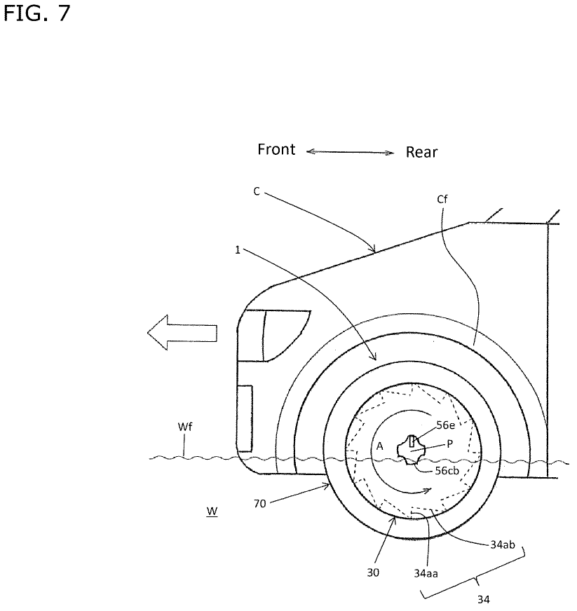

FIG. 7 is an explanatory diagram illustrating the vehicle equipped with the wheels according to the first embodiment, moving forward with part thereof submerged in water.

As shown in FIGS. 6 and 7, the plurality of paddle portions 34 of the present embodiment, which are provided in the outer peripheral surface portion 32 of the wheel cover portion 30, are recess-shaped portions that each have the first surface 34aa and the second surface 34ab. As viewed in the direction of the central axis P, the first surfaces 34aa are arranged on straight lines in a radial pattern centered around the central axis P, and the second surfaces 34ab are substantially parallel to tangents to a circle centered around the central axis P. In the case of the left wheel cover portion 30, the paddle portions 34 are arranged in a shape of circular saw teeth so that the first surfaces 34aa are rear surfaces of the paddle portions 34 and the second surfaces 34ab are front surfaces of the paddle portions 34, on the assumption that the direction of the rotation for moving the vehicle forward (arrow A direction) is toward the front. Also in the case of the right wheel cover portion (not shown), the paddle portions are arranged in a shape of circular saw teeth so that the first surfaces of the paddle portions are rear surfaces of the paddle portions and the second surfaces are front surfaces, on the assumption that the direction of the rotation for moving the vehicle forward is toward the front. Arranging the plurality of paddle portions 34 in a shape of circular saw teeth in the circumferential direction facilitates the generation of propulsion force for propelling the vehicle C forward using the paddle portions 34 through the rotation of the wheel 1 for moving the vehicle C forward (rotation in the arrow A direction). This feature will be described in more detail below.

In the present embodiment, there is no distinction between left and right wheel portions 10, but there is a distinction between the left and right wheel cover portions 30. That is, the orientation of the paddle portions 34 (orientation of the circular saw teeth) in the left wheel portions 10 and that in the right wheel portions 10 are opposite to each other. It is therefore appropriate to attach the left wheel cover portions 30 to the left wheel portions 10, and attach the right wheel cover portions to the right wheel portions.

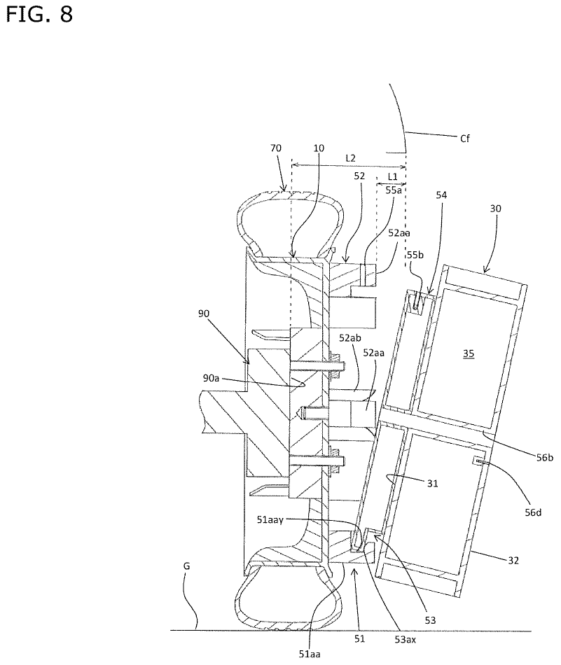

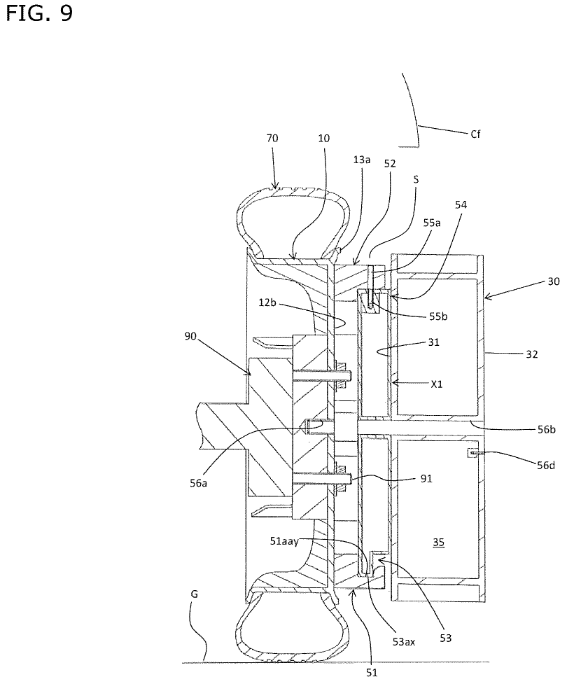

FIG. 8 is a longitudinal sectional view for illustrating a first procedure for attaching the wheel cover portion to the wheel portion of the first embodiment. FIG. 9 is a longitudinal sectional view for illustrating a second procedure for attaching the wheel cover portion to the wheel portion of the first embodiment.

As shown in FIGS. 8 and 9, the wheel cover portion 30 has, on the central axis P, a center hole 56b that penetrates from the inner surface portion 31 to the outer surface portion 32. The wheel cover portion 30 further has, at a location in proximity to the center hole 56b on the outer surface portion 32, a closed-end threaded hole 56d into which a stopper screw 56e described below (see FIG. 3) is screwed.

### <Attachment/Detachment Mechanism Portion>

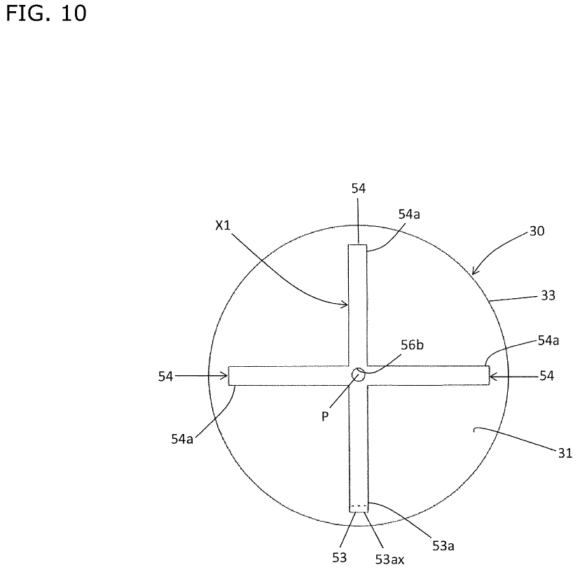

FIG. 10 is an external view of the inner surface of the wheel cover portion that is opposed to the wheel portion in the wheel according to the first embodiment.

The attachment/detachment mechanism portion 50 includes first mating portions 51 and 52 provided on the outer surface 12b of the wheel portion 10 as shown in FIG. 5, and second mating portions 53 and 54 provided on the inner surface portion 31 of the wheel cover portion 30 as shown in FIG. 10 so as to be fittable into the first mating portions 51 and 52. The attachment/detachment mechanism portion 50 has one first mating portion 51 and one corresponding second mating portion 53, and three first mating portions 52 and three corresponding second mating portions 54. As shown in FIG. 3, the attachment/detachment mechanism portion 50 further includes a first fixing portion 55 and a second fixing portion 56 that releasably fix mating between the first mating portions 51 and 52, and the second mating portions 53 and 54.

### <<First Mating Portion>>

As shown in FIG. 5, the first mating portion 51 has a mating recess portion 51a, and the first mating portions 52 each have a second mating recess portion 52a. The mating recess portions 51a and 52a are arranged on straight lines in a radial pattern centered around the central axis P on the outer surface 12b of the wheel portion 10, and on a circle centered around the central axis P. In the present embodiment, each of the first mating portions 51 and 52, and a corresponding one of the bolt insertion holes 16 are arranged on the same straight line among the straight lines in the radial pattern centered around the central axis P.

The mating recess portion 51a has a block-shaped first positioning member 51aa provided on one of the straight lines in the radial pattern centered around the central axis P, and a pair of block-shaped second positioning members 51ab provided on opposite sides of the first positioning member 51aa in the circumferential direction. It should be noted that the first positioning member 51aa and the pair of second positioning members 51ab may be connected and integrated with each other as a single member that constitutes the mating recess portion 51a.

The first positioning member 51aa and the pair of second positioning members 51ab form a U-shaped mating recess portion 51a that is open toward the central axis P. The first positioning member 51aa positions the second mating portion 53 in the radial direction, and the pair of second positioning members 51ab positions the second mating portion 53 in the circumferential direction.

Furthermore, the first positioning member 51aa has a supporting surface 51aax parallel to the outer surface 12b of the wheel portion 10 and a hook-shaped locking recess portion 51aay that is open inward (toward the central axis P) in the radial direction (see also FIG. 4).

As shown in FIG. 5, like the mating recess portion 51a, the other three mating recess portions 52a each have a block-shaped first positioning member 52aa and a pair of block-shaped second positioning members 52ab. The first positioning members 52aa are provided on three straight lines at equal intervals in a radial pattern centered around the central axis P. Each pair of second positioning members 52ab is provided on opposite sides of the corresponding first positioning member 52aa in the circumferential direction. Each of the first positioning members 52aa and the corresponding pair of second positioning members 52ab form a U-shaped mating recess portion 52a that is open toward the central axis P. The first positioning members 52aa position the second mating portions 54 in the radial direction, and the pairs of second positioning members 51ab position the second mating portions 53 in the circumferential direction.

Furthermore, each of the first positioning members 52aa has a supporting surface 52aax parallel to the outer surface 12b of the wheel portion 10 and a restricting surface 52aay perpendicular to the supporting surface 52aax (see FIG. 4). However, none of the first positioning members 52aa have a recess portion, such as the locking recess portion 51aay of the first positioning member 51aa, at the location of the restricting surface 52aay. In this respect, the configuration of the mating recess portion 51a differs from the configuration of the other three mating recess portions 52a.

Inner edges of the second positioning members 52ab in the two mating recess portions 52a adjacent to the mating recess portion 51a are chamfered (see also FIG. 4).

The four first mating portions 51 and 52 are, for example, made of metal and fixed to the outer surface 12b of the wheel portion 10 by welding, screwing, adhesive bonding, or a combination of screwing and adhesive bonding, among other methods.

The present embodiment has been described using an example in which four first mating portions 51 and 52 are provided at 90° central angle intervals around the central axis P on the outer surface 12b of the wheel portion 10. Although not shown, the first mating portions 51 and 52 may be formed using a single ring-like member having a closed annular shape. In other words, a single ring-like member (not shown) centered around the central axis P may be provided on the outer surface 12b of the wheel portion 10, and the four mating recess portions 51a and 52a may be provided in the ring-like member at 90° central angle intervals around the central axis P. In this case, the present embodiment can be considered to include a single ring-like member having a first mating portion including four mating recess portions 51a and 52a.

As shown in FIG. 4, a projection dimension of the first positioning members 51aa and 52aa and the second positioning members 51ab and 52ab from the outer surface 12b of the wheel portion 10 is greater than a projection dimension of mating protrusion portions 53a and 54a from the inner surface portion 31 on the wheel cover portion 30. Furthermore, the projection dimension of the mating protrusion portions 53a and 54a from the inner surface portion 31 of the wheel cover portion 30 is slightly greater than a projection dimension of the first positioning members 51aa and 52aa and the second positioning members 51ab and 52ab from the supporting surfaces 51aax and 52aax. This configuration prevents the wheel cover portion 30 from making contact with the first mating portions 51 and 52 (see FIG. 3).

### <<Second Mating Portion>>

As shown in FIG. 10, the second mating portions 53 and 54 have the plurality of mating protrusion portions 53a and 54a arranged on straight lines at equal intervals in a radial pattern centered around the central axis P on the inner surface portion 31 of the wheel cover portion 30. The present embodiment includes four second mating portions 53 and 54. The four second mating portions 53 and 54 have four mating protrusion portions 53a and 54a provided at 90° central angle intervals around the central axis P in the circumferential direction. Specifically, the four second mating portions 53 and 54 of the present embodiment are substantially integrated as being four end portions of a cross-shaped protrusion forming member X1 centered on the central axis P. The present embodiment can therefore be considered to include a single cross-shaped second mating portion having four mating protrusion portions 53a and 54a. Alternatively, only the four end portions of the cross-shaped protrusion forming member X1 may be employed, and the other portions thereof may be omitted, in which case, the inner surface portion 31 of the wheel cover portion 30 is actually provided with four second mating portions 53 and 54.

As shown in FIG. 10, the cross-shaped protrusion forming member X1 is a metal or resin member formed by integrating two square pipes at right angles to each other, and is fixed to the inner surface portion 31 of the wheel cover portion 30 by screwing, adhesive bonding, or a combination of screwing and adhesive bonding, among other methods.

The mating protrusion portion 53a, which is one of the four mating protrusion portions 53a and 54a, has an extension portion 53ax extending outward in the radial direction (see FIG. 4). The extension portion 53ax is fitted into and latched to the locking recess portion 51aay of the first mating portion 51 when the wheel cover portion 30 is attached to the wheel portion 10.

The mating protrusion portions 54a, which are the other three of the four mating protrusion portions 53a and 54a, are fitted into the respective mating recess portions 52a of the three first mating portions 52 when the wheel cover portion 30 is attached to the wheel portion 10. For this reason, the four first mating portions 51 and 52, and the four second mating portions 53 and 54 have shapes and dimensions that ensure a fit therebetween without wobbling looseness.

### <<First Fixing Portion>>

As shown in FIG. 3, the first fixing portion 55 maintains the engagement of the plurality of first mating portions 51 and 52 (see FIG. 5) with the plurality of second mating portions 53 and 54 (see FIG. 10). As shown in FIGS. 3 and 4, the first fixing portion 55 has: a first insertion portion 55a provided in one of the first mating portions 52 (see FIG. 5), not the first mating portion 51 having the locking recess portion 51aay; a second insertion portion 55b provided in one of the second mating portions 54 (see FIG. 10) that are mated with the first mating portions 52; and a bolt member 55c that is inserted into the first insertion portion 55a and the second insertion portion 55b. Furthermore, at least one of the first insertion portion 55a or the second insertion portion 55b has a threaded hole into which the bolt member 55c can be screwed.

In the present embodiment, the first insertion portion 55a is a hole that radially penetrates through the first positioning member 52aa of the one first mating portion 52, which is located at a central angle of 180° relative to the first mating portion 51 having the locking recess portion 51aay. This first positioning member 52aa also functions as a bolt supporting portion having the first insertion portion 55a. The second insertion portion 55b is a threaded hole provided in an radially-outward-facing end surface of the mating protrusion portion 54a of the one second mating portion 54, which is coupled with the first mating portion 52 having the first insertion portion 55a. Once the plurality of first mating portions 51 and 52 have been mated with the plurality of second mating portions 53 and 54, the first insertion portion 55a and the second insertion portion (threaded hole) 55b are in communication with each other. The first fixing portion 55 further has the bolt member 55c that is inserted into the first insertion portion 55a and screwed into the second insertion portion 55b. Preferably, the bolt member 55c is a wing bolt that can be held and turned with fingers.

### <<Second Fixing Portion>>

As shown in FIG. 4, the second fixing portion 56 has the center threaded hole portion 56a provided on the central axis P in the wheel portion 10, a center hole 56b provided on the central axis P in the wheel cover portion 30, and a center bolt member 56c (see FIG. 3) that is screwed into the center threaded hole portion 56a through the center hole 56b.

As shown in FIG. 4, the center threaded hole portion 56a extends from the outer surface 12b of the disk portion 12 of the wheel portion 10 partway into the thickness of the thickened portion 14.

As shown in FIG. 10, the center hole 56b penetrates through the wheel cover portion 30 and a central intersection portion of the cross-shaped protrusion forming member X1 constituting the second mating portions 53 and 54 (see FIG. 4).

As shown in FIG. 3, the center bolt member 56c has a male thread portion 56ca provided at a bolt tip thereof to be screwed into the center threaded hole portion 56a and a handle portion 56cb provided at a bolt head thereof (bolt base end).

As shown in FIGS. 3 and 4, the second fixing portion 56 further has the threaded hole 56d provided at a location in proximity to the center hole 56b in the outer surface portion 32 of the wheel cover portion 30, an insertion hole 56f that penetrates through the handle portion 56cb of the center bolt member 56c in a direction parallel to the direction of the central axis P, and the stopper screw 56e that is screwed into the threaded hole 56d through the insertion hole 56f. Preferably, the stopper screw 56e is a wing bolt that can be held and turned with fingers. The second fixing portion 56 may have a plurality of threaded holes 56d arranged on a circle centered around the central axis P.

### <Attachment and Detachment of Wheel Cover Portion to and From Wheel Portion>

The wheel 1 according to the present embodiment can be switched to an on-land mode, in which the wheel cover portion 30 is detached from the wheel portion 10 as shown in FIG. 8, for the vehicle C (see FIG. 1) to run on land. In this case, the outer surface 12b of the wheel portion 10 having the plurality of first mating portions 51 and 52 (the first positioning members 51aa and 52aa, and the second positioning members 51ab and 52ab shown in FIG. 5) is exposed to the outside. In order to keep the outer surface 12b covered, a replacement wheel cover (dish-shaped wheel cover, not shown) may be attached to the outer surface 12b. The replacement wheel cover has, at the rotational center, an insertion hole into which the center bolt member 56c can be inserted, so that the replacement wheel cover can be secured to the wheel portion 10 using the center bolt member 56c.

In the present embodiment, preferably, a lower end of each fender Cf of the vehicle C is located further outward than the plurality of first mating portions 51 and 52 on the wheel portion 10 by a predetermined fender clearance L1 as shown in FIGS. 1 and 8. In other words, the plurality of first mating portions 51 and 52 (see FIG. 5) on the wheel portion 10 are preferably located further inward than the lower end of the corresponding fender Cf by the predetermined fender clearance L1. Considering this point, it is preferable to determine the dimensions of the components of the wheel 1 (wheel portion 10, in particular) on the basis of a distance L2 from the end surface 90a of the hub 90 to the lower end of the fender Cf.

When the wheel 1 is switched from the on-land mode to an on-water mode, the replacement wheel cover, if attached, is removed first. Next, as shown in FIG. 8, the wheel cover portion 30 is attached to the wheel portion 10. To facilitate the attachment, the first mating portion 51, which has the locking recess portion 51aay, on the wheel portion 10 is preferably positioned toward the bottom. When the wheel cover portion 30 is attached, the extension portion 53ax of the second mating portion 53 on the wheel cover portion 30 is inserted into the locking recess portion 51aay of the first mating portion 51 positioned toward the bottom at an angle from above to latch the extension portion 53ax to the locking recess portion 51aay as shown in FIG. 8. With the extension portion 53ax latched to the locking recess portion 51aay, the wheel cover portion 30 is swung toward the wheel portion 10 as shown in FIG. 9. Consequently, the mating protrusion portion 53a of the second mating portion 53 (see FIG. 10) is fitted into the mating recess portion 51a of the first mating portion 51 (see FIG. 5), and the mating protrusion portions 54a of the other three second mating portions 54 (see FIG. 10) are fitted into the mating recess portions 52a of the other three first mating portions 52 (see FIG. 5). The left wheel cover portion 30, for example, is attached to the left wheel portion 10, so that the first surface 34aa of the lowermost paddle portion 34 faces rearward (see FIG. 7).

As shown in FIGS. 8 and 9, the plurality of second mating protrusion portions 53a and 54a of the plurality of mating portions 53 and 54 (see FIG. 10) can be quickly fitted into the plurality of mating recess portions 51a and 52a of the plurality of first mating portions 51 and 52 (see FIG. 5) in one step by swinging the wheel cover portion 30 toward the wheel portion 10 about a fulcrum at the extension portion 53ax latched to the locking recess portion 51aay. Furthermore, the second insertion portion 55b of the second mating portion 54 is placed in communication with the first insertion portion 55a of the first mating portion 52 (see FIG. 9). Meanwhile, the mating protrusion portions 53a and 54a abut and are thereby supported on the supporting surfaces 51aax and 52aax of the respective mating recess portions 51a and 52a, and a space S large enough for inserting fingers is formed between one of the rims 13a of the wheel portion 10 and the inner surface portion 31 of the wheel cover portion 30 (see FIG. 9). A space is formed also between the outer surface 12b of the wheel portion 10 and the protrusion forming member X1, and thus the protrusion forming member X1 does not come into contact with the fixing bolts 91 of the hub 90 (see FIG. 9).

In this state, the wheel cover portion 30 is not yet fixed to the wheel portion 10. The next step is therefore to insert the bolt member 55c of the first fixing portion 55 into the first insertion portion 55a and screw the bolt member 55c into the second insertion portion (threaded hole) 55b (see FIG. 3). In this configuration, the space S between the rim 13a of the wheel portion 10 and the inner surface portion 31 of the wheel cover portion 30 allows fingers to be inserted therein and turn the bolt member 55c (see FIG. 3). Thus, the plurality of first mating portions 51 and 52 (see FIG. 5) and the plurality of second mating portions 53 and 54 (see FIG. 10) are fixed in a mutually engaged state. Since the engagement between the plurality of first mating portions 51 and 52, and the plurality of second mating portions 53 and 54 is fixed with the bolt member 55c, the next fixing action can be performed without requiring the wheel cover portion 30 to be held by hand. The attachment can be considered complete with the fixation using the first fixing portion 55. However, as shown in FIG. 3, the present embodiment makes it possible to attach the wheel cover portion 30 to the wheel portion 10 more securely using the second fixing portion 56.

As shown in FIG. 3, the wheel cover portion 30 is fixed using the second fixing portion 56 by inserting the center bolt member 56c into the center hole 56b in the wheel cover portion 30 (see FIG. 4) and screwing the center bolt member 56c into the center threaded hole 56a in the wheel portion 10. Furthermore, as shown in FIG. 3, the stopper screw 56e is inserted into the insertion hole 56f of the handle portion 56cb (see FIG. 4) and screwed into the threaded hole 56d in the wheel cover portion 30. This prevents the center bolt member 56c from loosening, and thus the wheel cover portion 30 is reliably secured to the wheel portion 10.

The wheel 1 according to the present embodiment having the foregoing configuration allows for easy and quick transition to the on-water mode through the attachment of the wheel cover portion 30 to the wheel portion 10 in the on-land mode in cases of heavy rain or a tsunami, for example, where roads are highly likely to be flooded and there is an urgent need to take action. In preparation for such a situation, the four wheel cover portions 30 can be stored in the trunk of the vehicle C, allowing for a quick response wherever flooding occurs.

When the wheel cover portion 30 is detached from the wheel portion 10, the stopper screw 56e is removed, the center bolt member 56c is removed, the bolt member 55c is removed, and then the wheel cover portion 30 is tilted to release the extension portion 53ax from the locking recess portion 51aay. The bolt member 55c may be removed before the center bolt member 56c is removed. The stopper screw 56e and the center bolt member 56c can be attached and detached easily and quickly with bare hands without the need to use a tool such as a wrench or a spanner. In other words, the attachment/detachment mechanism portion 50 makes it easy to attach and detach the wheel cover portion 30 to and from the wheel portion 10. When the wheel cover portion 30 is attached to the wheel portion 10, the wheel cover portion 30 is moved toward the wheel portion 10 with the extension portion 53ax latched to the locking recess portion 51aay, and the mating protrusion portions 54a are easily and quickly fitted into the mating recess portions 52a for positioning. Furthermore, in the positioned state where the mating protrusion portions 53a and 54a are in the respective mating recess portions 51a and 52a, the wheel cover portion 30 can be fixed to the wheel portion 10 by inserting the bolt member 55c into the first insertion portion 55a of at least one bolt supporting portion and the second insertion portion 55b, and screwing the bolt member 55c into the threaded hole. Furthermore, in the positioned state where the mating protrusion portions 53a and 54a are in the respective mating recess portions 51a and 52a, the wheel cover portion 30 can be fixed to the wheel portion 10 by inserting the center bolt member 56c into the center hole 56b in the wheel cover portion 30 and screwing the center bolt member 56c into the center threaded hole portion 56a in the wheel portion 10. Furthermore, the stopper screw 56e helps prevent the center bolt member 56c screwed into the center threaded hole portion 56a from loosening.

As described above, in the case of the wheel 1 according to the present embodiment, the wheel cover portion 30 can be attached to and detached from the wheel portion 10 easily and quickly. By contrast, in the case of the thrust force generation mechanism of the amphibious vehicle disclosed in PTL 1, the attachment of each paddle member to the corresponding rear wheel is completed by removing the plurality of (usually four or more) nuts screwed onto the plurality of fixing bolts for the rear wheel hub using a tool, inserting the plurality of fixing bolts into the plurality of bolt insertion holes of the paddle member, and then screwing and thereby tightening the plurality of nuts back onto the plurality of fixing bolts using the tool. This procedure is performed in the opposite order to attach the paddle member to the rear wheel. As such, the attachment and detachment of the paddle members to and from the rear wheels are time-consuming.

### <Effects of Wheels in On-Water Mode>

As shown in FIG. 7, when the vehicle C is to move forward with part thereof submerged in water, forward propulsion force is generated by rotating the wheels 1 switched to the on-water mode in the direction for moving the vehicle C forward (arrow A direction), and thus causing mainly the first surfaces 34aa of respective paddle portions 34 located in the lower half of the plurality of paddle portions 34 to push the water W rearward. In this case, not only the buoyancy of the vehicle body of the vehicle C but also the buoyancy of the tires 70 filled with air and the buoyancy of the wheel cover portion 30 containing air in the hermetically sealed inner space portion 35 act to allow upper portions of the wheels 1 to float easily above water surface Wf. As long as the upper portions of the wheel cover portions 30 are floating above the water surface Wf, upper ones of the rotating paddle portions 34 are prevented from pushing the water W forward while lower ones of the rotating paddle portions 34 are pushing the water W rearward, facilitating the generation of forward propulsion force. In addition, the outer surface portions 32 of the wheel cover portions 30 are flat surfaces and do not have blade-shaped paddle members such as disclosed in PTL 1. It is therefore less likely that eddy currents that contribute little to the propulsion are generated in an area of each outer surface portion 32 in proximity to the central axis P. This configuration also facilitates the generation of propulsion force for moving the vehicle C forward using the wheels 1.

The wheel cover portions 30, which are hollow, are lightweight and therefore Besides, in the case of the four-wheel-drive (all-wheel-drive) vehicle C, easy to rotate. the four front and rear wheels 1 contribute to the generation of propulsion force, making it possible to generate greater propulsion force than in the case of a two-wheel-drive (front-wheel-drive or rear-wheel-drive) vehicle. In a case where an amphibious vehicle, which is an example of the vehicle C, runs somewhere where the vehicle completely floats on the water (for example, a deep river, a pond, a lake, or sea), for example, it is advantageous in terms of water resistance that the vehicle C is a four-wheel-drive vehicle, because rotating the four wheels 1 thereof generates greater propulsion force than rotating two wheels 1 of a two-wheel-drive vehicle. For another example, in a case where an off-road vehicle, which is an example of the vehicle C, crosses a river having a depth that allows the off-road vehicle to pass therethrough, the vehicle is preferably a four-wheel-drive vehicle as being able to finish crossing the river faster than a two-wheel-drive vehicle. In this case, it is less likely that an accident such as breakage of a paddle member due to contact with stones or rocks on the riverbed will happen since no paddle member is provided on the outer surface portions 32 of the wheel cover portions 30.

In the case of the wheels 1 according to the present embodiment, rotating the wheels 1 in the direction for moving the vehicle C forward (arrow A direction) do not generate forward propulsion force successfully if the wheel cover portions 30 are attached to the wheel portions 10 in reversed positions, which in other words is if the left wheel cover portions are attached to the right wheel portions and the right wheel cover portions are attached to the left wheel portions. This is because the first surfaces 34aa of the lowermost paddle portions 34 (see FIG. 7) face forward in this arrangement. In this case, rotating the wheels 1 in a direction opposite to the arrow A direction successfully generates rearward propulsion force.

### Modification Example of First Embodiment

In the first fixing portion 55 of the first embodiment (see FIGS. 3 and 4), the second insertion portion 55b may be a hole that does not have a female thread and the first insertion portion 55a may be a threaded hole, or both the first insertion portion 55a and the second insertion portion 55b may be threaded holes.

Furthermore, in the second fixing portion 56, the threaded hole 56d may be a hole that does not have a female thread and the insertion hole 56f may be a threaded hole, or the insertion hole 56f may be a threaded hole in addition to the threaded hole 56d.

### Second Embodiment

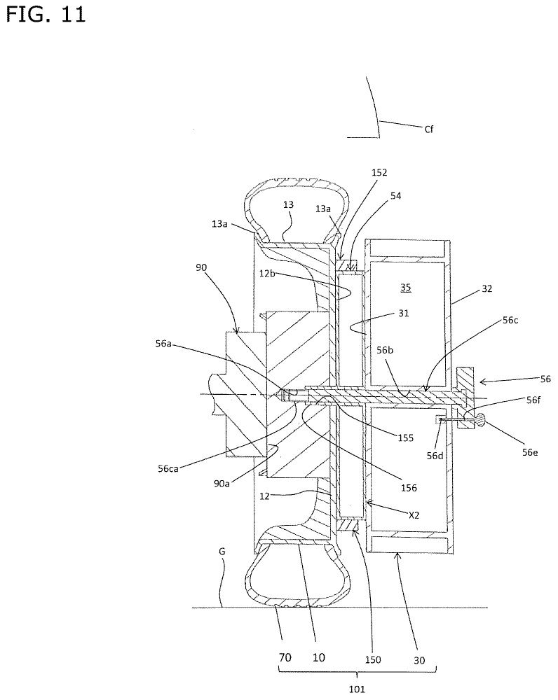

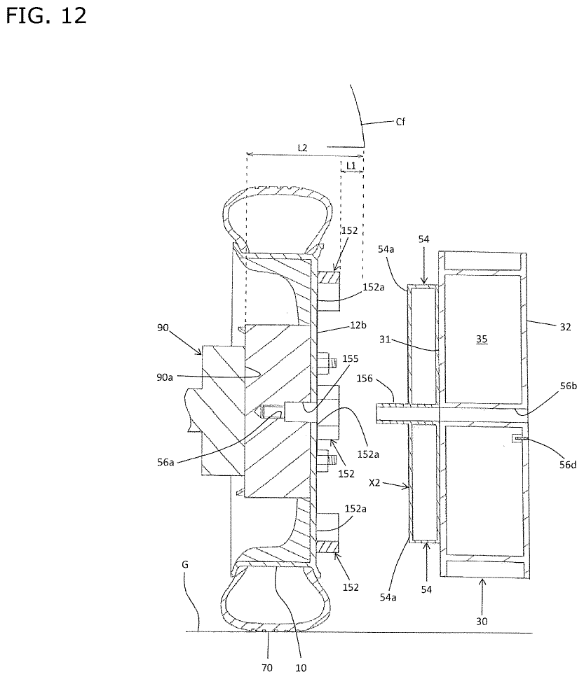

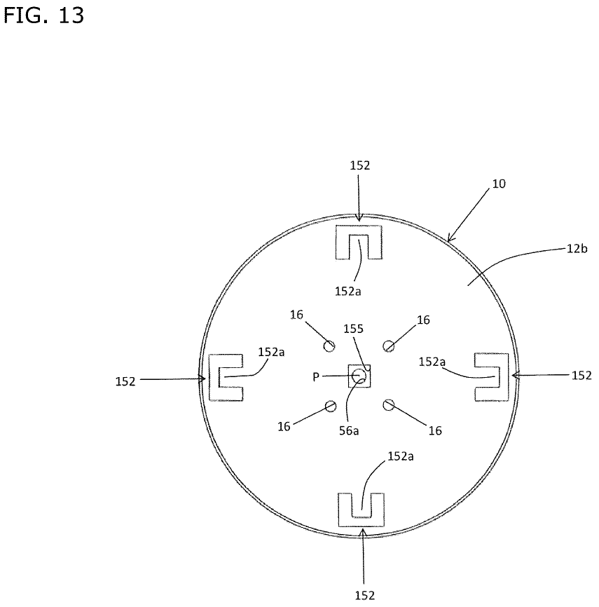

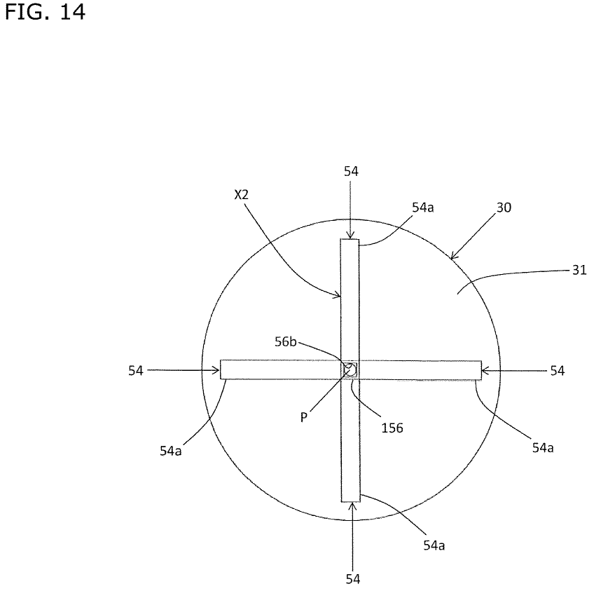

FIG. 11 is a longitudinal sectional view of a wheel according to a second embodiment taken along the central axis of rotation thereof. FIG. 12 is a longitudinal sectional view for illustrating a procedure for attaching a wheel cover portion to a wheel portion of the second embodiment. FIG. 13 is an external view of an outer surface of the wheel portion of the wheel according to the second embodiment. FIG. 14 is an external view of an inner surface of the wheel cover portion of the wheel according to the second embodiment. It should be noted that in FIGS. 11 to 14, the same elements as those in FIGS. 3 to 10 are labeled with the same reference signs as in FIGS. 3 to 10.

As shown in FIG. 11, a wheel 101 according to the second embodiment includes an attachment/detachment mechanism portion 150 that differs in configuration from the attachment/detachment mechanism portion 50 of the wheel 1 according to the first embodiment (see, for example, FIGS. 3 to 5). Other than that, the second embodiment has substantially the same configuration as the first embodiment. The following mainly describes differences between the second embodiment and the first embodiment.

The attachment/detachment mechanism portion 150 of the second embodiment has: four first mating portions 152 provided on an outer surface 12b of a wheel portion 10 shown in FIG. 13; four second mating portions 54 provided on an inner surface portion 31 of a wheel cover portion 30 shown in FIG. 14 so as to be fittable into the four first mating portions 152; a polygonal hole portion 155 provided as a third mating portion in an outer surface 12b of the wheel portion 10 shown in FIG. 13 so as to be in communication with a center threaded hole portion 56a; a polygonal boss portion 156 provided as a fourth mating portion on the inner surface portion 31 of the wheel cover portion 30 shown in FIG. 14 so as to be fittable into the polygonal hole portion 155 and to be in communication with a center hole 56b; and a fixing portion 56 shown in FIG. 11 that releasably fixes mating between the first mating portions 152 and the second mating portions 54. The second embodiment omits a fixing portion corresponding to the first fixing portion 55 (see FIG. 3) in the first embodiment.

### <<First Mating Portion>>

As shown in FIG. 13, the four first mating portions 152 have four mating recess portions 152a arranged on a circle centered around the central axis P and on straight lines in a radial pattern centered around the central axis P on the outer surface 12b of the wheel portion 10. Each of the mating recess portions 152a is formed of a U-shaped positioning block that is open toward the central axis P. Each of the mating recess portions 152a is also open in a direction parallel to the central axis P. The present embodiment has four bolt insertion holes 16 arranged on a circle and on four straight lines in a radial pattern centered around the central axis P, and the four mating recess portions 152a are arranged at equal intervals (90° central angle intervals) on another circle and on other four straight lines in the radial pattern that are located between the four straight lines on which the bolt insertion holes 16 are arranged. None of the mating recess portions 152a have the supporting surface 52aax (see FIG. 4), which is provided in each mating recess portion 52a of the first embodiment.

### <<Second Mating Portion>>

As shown in FIG. 14, the four second mating portions 54 have four mating protrusion portions 54a arranged on four straight lines in a radial pattern centered around the central axis P on the inner surface portion 31 of the wheel cover portion 30. In the present embodiment, four end portions of a cross-shaped protrusion forming member X2 centered on the central axis P form the four mating protrusion portions 54a. The present embodiment can therefore be considered to include a single second mating portion having four mating protrusion portions 54a. Alternatively, only the four end portions of the cross-shaped protrusion forming member X2 may be employed, and the other portions thereof may be omitted, in which case, the inner surface portion 31 of the wheel cover portion 30 is actually provided with four second mating portions 54. A projection dimension of the protrusion forming member X2 from the inner surface portion 31 of the wheel cover portion 30 is greater than a projection dimension of the first mating portions 152 from the outer surface 12b of the wheel portion 10. None of the second mating portions 54 have the extension portion 53ax (see FIGS. 4 and 10), which is provided on the second mating portion 53 of the first embodiment.

### <<Third Mating Portion>>

As shown in FIG. 13, the polygonal hole portion 155 of the present embodiment, which is provided as the third mating portion, is a square hole portion having a square transverse cross-sectional shape in a direction perpendicular to the central axis P. In this case, four surfaces of the square hole portion that are parallel to the central axis P are oriented in such directions as to face the respective mating recess portions 152a straight on.

### <<Fourth Mating Portion>>

As shown in FIG. 14, the polygonal boss portion 156 of the present embodiment, which is provided as the fourth mating portion, is a square pipe protruding on the central axis P from a square region of a central intersection portion of the protrusion forming member X2, and has a shape and a size that ensure a fit into the polygonal hole portion 155 without rattling looseness. The length of the polygonal boss portion 156 is equal to or slightly shorter than the depth of the polygonal hole portion 155 (see FIGS. 11 and 12).

### <<Fixing Portion>>

The fixing portion 56 shown in FIG. 11 has the same configuration as the second fixing portion 56 of the first embodiment (see FIG. 3). The fixing portion 56 has: a center threaded hole portion 56a provided on the central axis P in the outer surface 12b of the wheel portion 10; a center hole 56b provided on the central axis P in the wheel cover portion 30; a center bolt member 56c that is screwed into the center threaded hole portion 56a through the center hole 56b; a threaded hole 56d provided at a location in proximity to the center hole 56b in an outer surface portion 32 of the wheel cover portion 30; an insertion hole 56f that penetrates through a handle portion 56cb of the center bolt member 56c in a direction parallel to the direction of the central axis P; and a stopper screw 56e that is screwed into the threaded hole 56d through the insertion hole 56f (see FIG. 12).

### <Attachment and Detachment of Wheel Cover Portion to and From Wheel Portion>

In the second embodiment, as shown in FIG. 12, the wheel cover portion 30 is lifted and the polygonal boss portion (fourth mating portion) 156 is inserted into the polygonal hole portion (third mating portion) 155 in the wheel portion 10 to attach the wheel cover portion 30 to the wheel portion 10. As shown in FIG. 11, the square boss portion 156 is fully inserted into the square hole portion 155, and thereby the mating protrusion portions 154a of the four second mating portions 54 (see FIG. 14) are fitted into the mating recess portions 152a of the four first mating portions 152 (see FIG. 13). That is, the insertion of the polygonal boss portion 156 into the polygonal hole portion 155 guides the fitting of the mating protrusion portions 154a into the respective mating recess portions 152a.

Then, as in the first embodiment, the center bolt member 56c shown in FIG. 11 is inserted into the center hole 56b in the wheel cover portion 30 and screwed into the center threaded hole 56a in the wheel portion 10. Furthermore, the stopper screw 56e is inserted into the insertion hole 56f of the handle portion 56cb and screwed into the threaded hole 56d in the wheel cover portion 30. This prevents the center bolt member 56c from loosening, and thus the wheel cover portion 30 is reliably secured to the wheel portion 10. In the second embodiment, the wheel cover portion 30 can be brought closer to the wheel portion 10 than in the first embodiment, because the protrusion forming member X2 abuts the outer surface 12b of the wheel portion 10.

When the wheel cover portion 30 is detached from the wheel portion 10, the stopper screw 56e is removed, the center bolt member 56c is removed, and then the wheel cover portion 30 is moved in the direction parallel to the central axis P to pull the polygonal boss portion 156 out of the polygonal hole portion 155.

The wheel 101 according to the second embodiment allows for quicker attachment and detachment of the wheel cover portion 30 to and from the wheel portion 10.

In the second embodiment, preferably, a lower end of each fender Cf of the vehicle C is located further outward than the plurality of first mating portions 152 on the wheel portion 10 by a predetermined fender clearance L1 as shown in FIG. 12. In other words, the plurality of first mating portions 152 on the wheel portion 10 are preferably located further inward than the lower end of the corresponding fender Cf by the predetermined fender clearance L1. Considering this point, it is preferable to determine the dimensions of the components of the wheel 101 on the basis of a distance L2 from the end surface 90a of the hub 90 to the lower end of the fender Cf.

### Third Embodiment

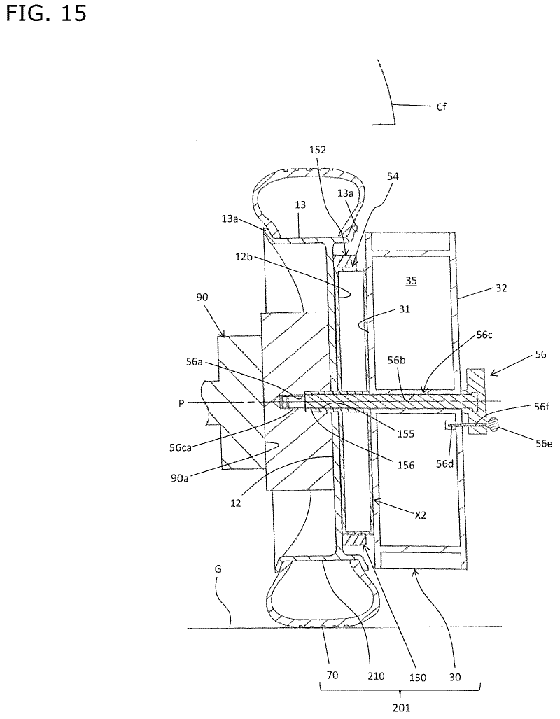

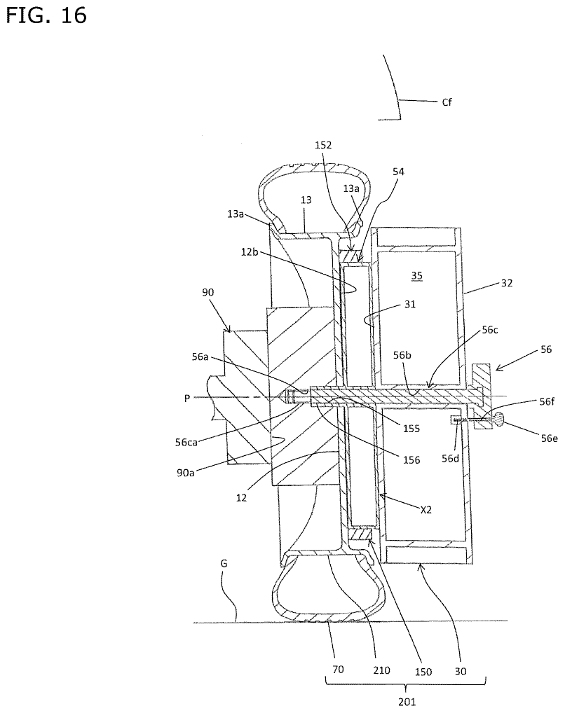

FIG. 15 is a longitudinal sectional view of a wheel according to a third embodiment taken along the central axis of rotation thereof. FIG. 16 is a longitudinal sectional view for illustrating a procedure for attaching a wheel cover portion to a wheel portion of the third embodiment. It should be noted that in FIGS. 15 and 16, the same elements as those in FIGS. 11 and 12 are labeled with the same reference signs as in FIGS. 11 and 12.

A wheel 201 according to the third embodiment shown in FIG. 15 has basically the same configuration as the wheel 101 according to the second embodiment (see FIG. 11) except for the following differences.

A disk portion 12 of a wheel portion 210 of the wheel 201 according to the third embodiment shown in FIG. 15 is located slightly inward (toward a hub 90). This configuration ensures that a plurality of first mating portions 152 on an outer surface 212b of the wheel portion 210 do not protrude further outward than an outer rim 13a as shown in FIG. 16 when a wheel cover portion 30 is detached from the wheel portion 210. In the third embodiment, the plurality of first mating portions 152 on the outer surface 212b of the wheel portion 210 and the outer rim 13a are located inward of an outer end of a tire 70.

In the third embodiment, preferably, a lower end of each fender Cf of the vehicle C is located further outward than the corresponding tire 70 by a predetermined fender clearance L1 as shown in FIG. 16. In other words, the tire 70 is preferably located further inward than the lower end of the corresponding fender Cf by the predetermined fender clearance L1. Considering this point, it is preferable to determine the dimensions of the components of the wheel 201 on the basis of a distance L2 from an end surface 92a of the hub 90 to the lower end of the fender Cf.

### Fourth Embodiment

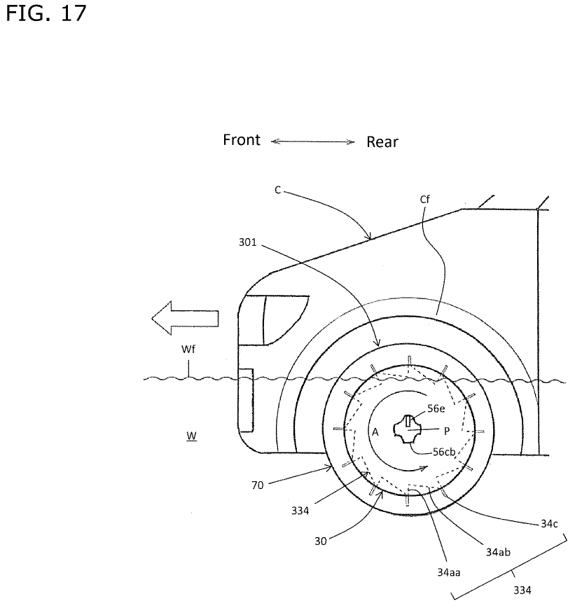

FIG. 17 is an explanatory diagram illustrating a vehicle equipped with wheels according to a fourth embodiment, moving forward in water. In FIG. 17, the same elements as those in FIG. 7 are labeled with the same reference signs as in FIG. 7.

A wheel 301 according to the fourth embodiment has substantially the same configuration as the first to third embodiments except for some differences in configuration of paddle portions. The following mainly describes differences between the fourth embodiment and the first to third embodiments.

Paddle portions 334 in the wheel 301 according to the fourth embodiment shown in FIG. 17 have a plurality of paddle portions 34a as in the first embodiment. In addition, the paddle portions 334 have a plurality of paddle fins 34c provided along an outer peripheral surface portion of a wheel cover portion 30 and protruding outward in the radial direction. The plurality of paddle fins 34c are provided at the locations of a plurality of peaks (between adjacent troughs) of the outer peripheral surface portion of the wheel cover portion 30. In other words, each of the paddle fins 34c is provided on an extension of a first surface 34aa of a corresponding one of the paddle portions 34.

The paddle portions 334 of the fourth embodiment have a greater area contributing to pushing water rearward with paddle portions 34 and paddle fins 34c located in the lower half of the paddle portions 334 when the wheel 301 rotates in the direction for moving the vehicle forward (arrow A direction), facilitating generation of greater propulsion force. Furthermore, having the plurality of paddle fins 34c, the paddle portions 334 can generate rearward propulsion force when the wheel 301 is rotated in a direction for moving the vehicle rearward (direction opposite to the arrow A direction).

### Modification Example of Fourth Embodiment

The first surfaces 34aa of the plurality of paddle portions 34 in the paddle portions 334 shown in FIG. 17 may each be a U-shaped or V-shaped indented surface rather than a flat surface as viewed in the direction of the central axis P. This shape helps increase the amount of water that is pushed by the paddle portions 34, further facilitating the generation of rearward propulsion force.

### Other Embodiments

The second fixing portion 56 of the first embodiment (see FIG. 3), and the fixing portions 56 of the second and third embodiments (see FIGS. 11 and 15) each have a configuration including the stopper screw 56e. However, a spring washer and a lock washer may be used instead of the stopper screw. In this case, the spring washer and the lock washer, not shown, are placed between the outer surface portion 32 of the wheel cover portion 30 and the handle portion 56cb of the center bolt member 56c, so that the spring washer presses a plurality of projections of the lock washer against the handle portion 56cb.

Preferred aspects of the present invention include combinations of any of the plurality of aspects described above.

Various modifications of the present invention are also possible as well as the embodiments described above. Such modifications should not be construed as not falling within the scope of the present invention. All changes which come within the meaning and range of equivalency of the claims are to be embraced within the present invention.

### REFERENCE SIGNS LIST

1, 101, 201, 301: Wheel
10: Wheel portion
12: Disk portion
12a: Inner surface
12b: Outer surface
13: Outer peripheral portion
13a: Rim
14: Thickened portion
15: Rib
16: Bolt insertion hole
30: Wheel cover portion
31: Inner surface portion
32: Outer surface portion
33: Outer peripheral surface portion
34, 234, 334: Paddle portion
34aa: First surface
34ab: Second surface
34c: Paddle fin
35: Inner space portion
50, 150: Attachment/detachment mechanism portion
51, 52, 152: First mating portion
51a, 52a, 152a: Mating recess portion
51aa, 52aa: First positioning member
51aax, 52aax: Supporting surface
51aay: Locking recess portion
51ab, 52ab: Second positioning member
52aay: Restricting surface
53, 54: Second mating portion
53a, 54a: Mating protrusion portion
53ax: Extension portion
55: First fixing portion
55a: First insertion portion
55b: Second insertion portion (threaded hole)
55c: Bolt member
56: Second fixing portion (fixing portion)
56a: Center threaded hole portion
56ax: Square hole portion
56b: Center hole
56bx: Square boss portion
56c: Center bolt member
56ca: Male thread portion
56cb: Handle portion
56d: Threaded hole
56e: Stopper screw
56f: Insertion hole
60: Nut member
70: Tire
90: Hub (wheel hub)
90a: End surface
91: Fixing bolt (hub bolt)
155: Polygonal hole portion (third mating portion)
156: Polygonal boss portion (fourth mating portion)
A: Arrow
C: Vehicle
Cf: Fender
L1: Fender clearance
L2: Distance
P: Central axis of rotation
S: Space
W: Water
Wf: Water surface
X1, X2: Protrusion forming member

What is claimed is:

1.-23. (canceled)

24. A wheel for a vehicle, the wheel comprising:
a wheel portion that is attached to a hub provided on an end of a drive wheel drive shaft in a body of the vehicle;
a wheel cover portion that is detachably attached to the wheel portion; and
an attachment/detachment mechanism portion that detachably fixes the wheel cover portion to the wheel portion, wherein
the wheel cover portion has a drum-like shape having a thickness in a direction of a central axis of the wheel portion and includes a plurality of recess-shaped paddle portions in an outer peripheral surface portion thereof,
the attachment/detachment mechanism portion has
a plurality of mating recess portions provided on the wheel portion,
a plurality of mating protrusion portions provided on the wheel cover portion so as to be fittable into the plurality of mating recess portions, and
a fixing portion that releasably fixes mating between the plurality of mating recess portions and the plurality of mating protrusion portions, and
the fixing portion has
a center threaded hole portion provided on the central axis in the wheel portion,
a center hole provided on the central axis in the wheel cover portion,
a center bolt member that is screwed into the center threaded hole portion through the center hole, and
a stopper screw that prevents the center bolt member screwed into the center threaded hole portion from loosening.

25. The wheel according to claim 24, wherein
the center bolt member has a handle portion provided at a bolt head thereof,
the fixing portion further has a threaded hole provided in proximity to the center hole in the wheel cover portion and an insertion hole that penetrates through the handle portion in a direction parallel to the central axis, and
the stopper screw is screwable into the threaded hole through the insertion hole.

26. The wheel according to claim 24, wherein
one mating protrusion portion of the plurality of mating protrusion portions has an extension portion extending outward in a radial direction, and
one mating recess portion of the plurality of mating recess portions has a hook-shaped locking recess portion that is open inward in the radial direction so as to receive the extension portion of the one mating protrusion portion.

27. The wheel according to claim 26, wherein
other mating recess portions of the plurality of mating recess portions are each open in a direction parallel to the central axis so as to receive other mating protrusion portions of the plurality of mating protrusion portions.

28. The wheel according to claim 27, wherein the other mating protrusion portions are fittable into the other mating recess portions with the extension portion latched to the locking recess portion.

29. The wheel according to claim 27, wherein
the fixing portion has
a bolt member that fixes at least one of the other mating protrusion portions fitted into the other mating recess portions to the wheel portion,
a bolt supporting portion that is provided in proximity to at least one of the other mating recess portions and supports the bolt member,
a first insertion portion that is provided in the bolt supporting portion and allows the bolt member to be inserted therein, and
a second insertion portion that is provided in the at least one of the other mating protrusion portions and allows the bolt member to be inserted therein, and
at least one of the first insertion portion or the second insertion portion has a threaded hole into which the bolt member is screwed.

30. The wheel according to claim 24, wherein the paddle portions have a plurality of paddle fins extending outward in the radial direction.

31. A wheel for a vehicle, the wheel comprising:
a wheel portion that is attached to a hub provided on an end of a drive wheel drive shaft in a body of the vehicle;
a wheel cover portion that is detachably attached to the wheel portion; and
an attachment/detachment mechanism portion that detachably fixes the wheel cover portion to the wheel portion, wherein
the wheel cover portion has a drum-like shape having a thickness in a direction of a central axis of the wheel portion and includes a plurality of recess-shaped paddle portions in an outer peripheral surface portion thereof,
the attachment/detachment mechanism portion has
a plurality of mating recess portions provided on the wheel portion,
a plurality of mating protrusion portions provided on the wheel cover portion so as to be fittable into the plurality of mating recess portions, and
a fixing portion that releasably fixes mating between the plurality of mating recess portions and the plurality of mating protrusion portions,
one mating protrusion portion of the plurality of mating protrusion portions has an extension portion extending outward in a radial direction, and
one mating recess portion of the plurality of mating recess portions has a hook-shaped locking recess portion that is open inward in the radial direction so as to receive the extension portion of the one mating protrusion portion,
wherein other mating recess portions of the plurality of mating recess portions are each open in a direction parallel to the central axis so as to receive other mating protrusion portions of the plurality of mating protrusion portions.

32. The wheel according to claim 31, wherein the other mating protrusion portions are fittable into the other mating recess portions with the extension portion latched to the locking recess portion.

33. The wheel according to claim 31, wherein
the fixing portion has
a bolt member that fixes at least one of the other mating protrusion portions fitted into the other mating recess portions to the wheel portion,
a bolt supporting portion that is provided in proximity to at least one of the other mating recess portions and supports the bolt member,
a first insertion portion that is provided in the bolt supporting portion and allows the bolt member to be inserted therein, and
a second insertion portion that is provided in the at least one of the other mating protrusion portions and allows the bolt member to be inserted therein, and
at least one of the first insertion portion or the second insertion portion has a threaded hole into which the bolt member is screwed.

34. The wheel for a vehicle according to claim 31, wherein
the fixing portion has
a center threaded hole portion provided on the central axis in the wheel portion,
a center hole provided on the central axis in the wheel cover portion,
a center bolt member that is screwed into the center threaded hole portion through the center hole, and
a stopper screw that prevents the center bolt member screwed into the center threaded hole portion from loosening,
wherein the center bolt member has a handle portion provided at a bolt head thereof,
the fixing portion further has a threaded hole provided in proximity to the center hole in the wheel cover portion and an insertion hole that penetrates through the handle portion in a direction parallel to the central axis, and
the stopper screw is screwable into the threaded hole through the insertion hole.

35. A wheel for a vehicle, the wheel comprising:
a wheel portion that is attached to a hub provided on an end of a drive wheel drive shaft in a body of the vehicle;
a wheel cover portion that is detachably attached to the wheel portion; and
an attachment/detachment mechanism portion that detachably fixes the wheel cover portion to the wheel portion, wherein
the wheel cover portion has a drum-like shape having a thickness in a direction of a central axis of the wheel portion and includes a plurality of recess-shaped paddle portions in an outer peripheral surface portion thereof,
the attachment/detachment mechanism portion has
a plurality of mating recess portions provided on the wheel portion,
a plurality of mating protrusion portions provided on the wheel cover portion so as to be fittable into the plurality of mating recess portions, and
a fixing portion that releasably fixes mating between the plurality of mating recess portions and the plurality of mating protrusion portions, and
the plurality of mating recess portions are each open toward the central axis in a direction perpendicular to the central axis so as to receive the plurality of mating protrusion portions,
wherein the fixing portion has
a center threaded hole portion provided on the central axis in the wheel portion,
a center hole provided on the central axis in the wheel cover portion,
a center bolt member that is screwed into the center threaded hole portion through the center hole, and
a stopper screw that prevents the center bolt member screwed into the center threaded hole portion from loosening,
wherein the center bolt member has a handle portion provided at a bolt head thereof,
the fixing portion further has a threaded hole provided in proximity to the center hole in the wheel cover portion and an insertion hole that penetrates through the handle portion in a direction parallel to the central axis, and
the stopper screw is screwable into the threaded hole through the insertion hole.

36. The wheel according to claim 35, wherein the plurality of mating recess portions are each U-shaped as viewed in the direction of the central axis

37. The wheel according to claim 35, wherein the plurality of mating recess portions position the plurality of mating protrusion portions in a radial direction and in a circumferential direction with respect to the central axis.

38. The wheel according to claim 35, wherein
one mating protrusion portion of the plurality of mating protrusion portions has an extension portion extending outward in a radial direction, and
one mating recess portion of the plurality of mating recess portions has a hook-shaped locking recess portion that is open inward in the radial direction so as to receive the extension portion of the one mating protrusion portion.

39. The wheel according to claim 38, wherein other mating protrusion portions of the plurality of mating protrusion portions are fittable into other mating recess portions of the plurality of mating recess portions with the extension portion latched to the locking recess portion.

40. The wheel according to claim 39, wherein
the fixing portion has
a bolt member that fixes at least one of the other mating protrusion portions fitted into the other mating recess portions to the wheel portion,
a bolt supporting portion that is provided in proximity to at least one of the other mating recess portions and supports the bolt member,
a first insertion portion that is provided in the bolt supporting portion and allows the bolt member to be inserted therein, and
a second insertion portion that is provided in the at least one of the other mating protrusion portions and allows the bolt member to be inserted therein, and
at least one of the first insertion portion or the second insertion portion has a threaded hole into which the bolt member is screwed.

41. The wheel according to claim 24, wherein the plurality of mating recess portions are each open toward the central axis in a direction perpendicular to the central axis so as to receive the plurality of mating protrusion portions.

42. The wheel according to claim 24, wherein the plurality of mating recess portions are each U-shaped as viewed in the direction of the central axis.

43. The wheel according to claim 24, wherein the plurality of mating recess portions position the plurality of mating protrusion portions in a radial direction and in a circumferential direction with respect to the central axis.
